(19) United States
(12) Patent Application Publication
(10) Pub. No.: US 2014/0170589 A1
(43) Pub. Date: Jun. 19, 2014

(54) LIGHTED TEETH CLEANING APPARATUS

(71) Applicant: Shona Huang, Plano, TX (US)

(72) Inventor: Shona Huang, Plano, TX (US)

(21) Appl. No.: 13/748,248

(22) Filed: Jan. 23, 2013

Related U.S. Application Data
(60) Provisional application No. 61/589,840, filed on Jan. 23, 2012.

(51) Int. Cl. A61C 1/08; A61C 1/00; A61C 17/06

(52) U.S. Cl. CPC A61C 1/088; A61C 17/043; A61C 1/0061
USPC 433/29

(57) ABSTRACT

A device for cleaning teeth with a light for the area being cleaned is described.

### CLAIM FOR PRIORITY

This application claims priority to U.S. Patent Application No. 61/589,840, filed Jan. 23, 2012, which is hereby incorporated by reference in its entirety.

### TECHNICAL FIELD

The present invention generally relates to teeth cleaning and tools used for accomplishing same.

### FIELD AND BACKGROUND OF THE INVENTION

This invention specifically relates to an improved device that gives off light and which is used for collecting and removing saliva and debris from the mouth of a patient.

During dental operations such as scaling, measuring, cleaning or any other dental operations performed within the mouth of a patient, it is desirable that the work area in the mouth be adequately lit and free of saliva/debris, in particular on the inside between the molars and the tongue.

Dental devices such as suction devices have, and still do utilize U-shaped plastic hollow tubes to evacuate the lower jaw area of patients during dental procedures. These devices are adequate for the removal of saliva and debris, but do not provide any lighting within the mouth, creating unnecessary strain on the dentist or hygienist. Accordingly, the need exists in the art for a dental suction device which will continuously and efficiently remove excess moisture from the patient's mouth under the best possible light conditions yet remain small in size and occupy as little space within the mouth as possible.

### SUMMARY OF THE INVENTION

In accordance with the present invention there is provided a lighted teeth cleaning apparatus device for use during dental procedures, such as scraping, scaling, rubbing, filling, cleaning and any other dental work done without the aid of an assistant. The device is bent to a desired shape, such as a U-shape, by the operator so that it fits into the mouth of the patient in the lower jaw area inside of the lower teeth. A preferred embodiment of the present invention is a suction device with a generally straight hollow tube with an enlarged base fitted with a plurality of slots and holes for moisture extraction. In addition, the tube is fitted with three surface mouth devices (SMD) light emitting diodes (LED), spaced such that the maximum amount of light is produced and directed upwards and forwards when the plastic tubular device is bent into a U-shape for inserting into the mouth between the tongue and lower teeth. The SMD LEDs are mounted and electrically connected together on a flexible printed circuit board made of polyester or polymide, to which copper conductive traces 0.5 oz.-0.0007 in. (0.018 mm) thick, are fixed. Two copper conducting 28 gauge wires are attached to the flexible circuit board and run along the top of the suction device to the location where the suction hose valve is located. These wires are the current carrying means whereby the 3 volt direct current (DC) battery power source is situated for lighting up the three 1420 mcd (milli candela) or more LEDs. The flexible circuit board, with the three SMD LEDs attached and the connecting power wires, are encapsulated and fixed in unmovable position on the plastic suction device by 3/8 in (5 mm) clear food grade Polyolefin heat shrink tubing.

Attached to the air suction supply tube, below the shut-off valve, will be located a cylinder housing two AAA batteries connected in series and an On-Off switch with a receptacle for receiving the connecting plug with the two wires affixed to the suction tube. It is the object of this invention to provide a well-lighted, flexible dental suction device for use in a patient's mouth during various dental procedures.

These and other objects of the invention will become apparent from the following diagrams, drawings and descriptions, and the appended claims.

### BRIEF DESCRIPTION OF THE DRAWINGS

FIG. 1 is a perspective view of certain aspects of the lighted teeth cleaning apparatus of the present invention.

FIG. 2 is a perspective view of complete assembly of the present invention.

FIG. 3 is a perspective view of a battery power source for use with the present invention. It identifies the objects to which the invention objects attach to.

FIG. 4 is a perspective view of factors of one aspect of the present invention.

### DETAILED DESCRIPTION OF INVENTION

The present invention now will be described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

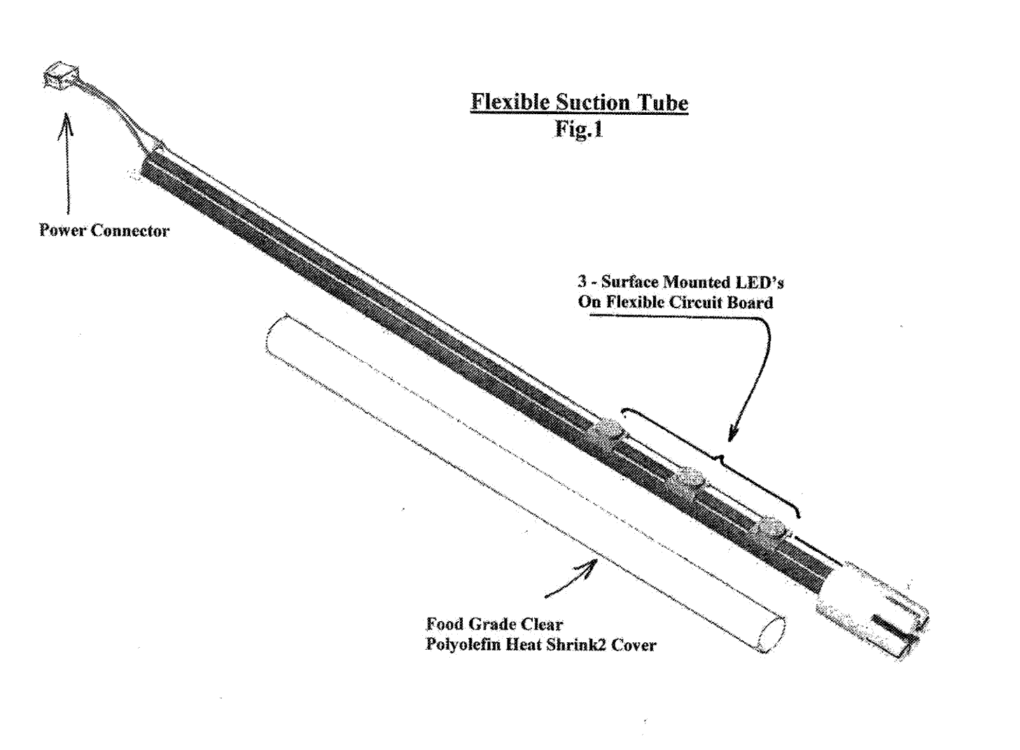

As shown in FIGS. 1-4, dental suction device has a hollow tubular stem fitted with three high intensity surface mount light emitting diodes positioned at the top one third of the total extension of the tube. These lights are positioned such that when the tube is bent into a semi U-shape, light is projected into the area of the mouth. The LED light strip is covered with a food grade clear polyolefin shrink wrap. FIG. 1 shows the suction tube with the power connecting wire extending from the opposing end to the plurality of holes moisture take up end.

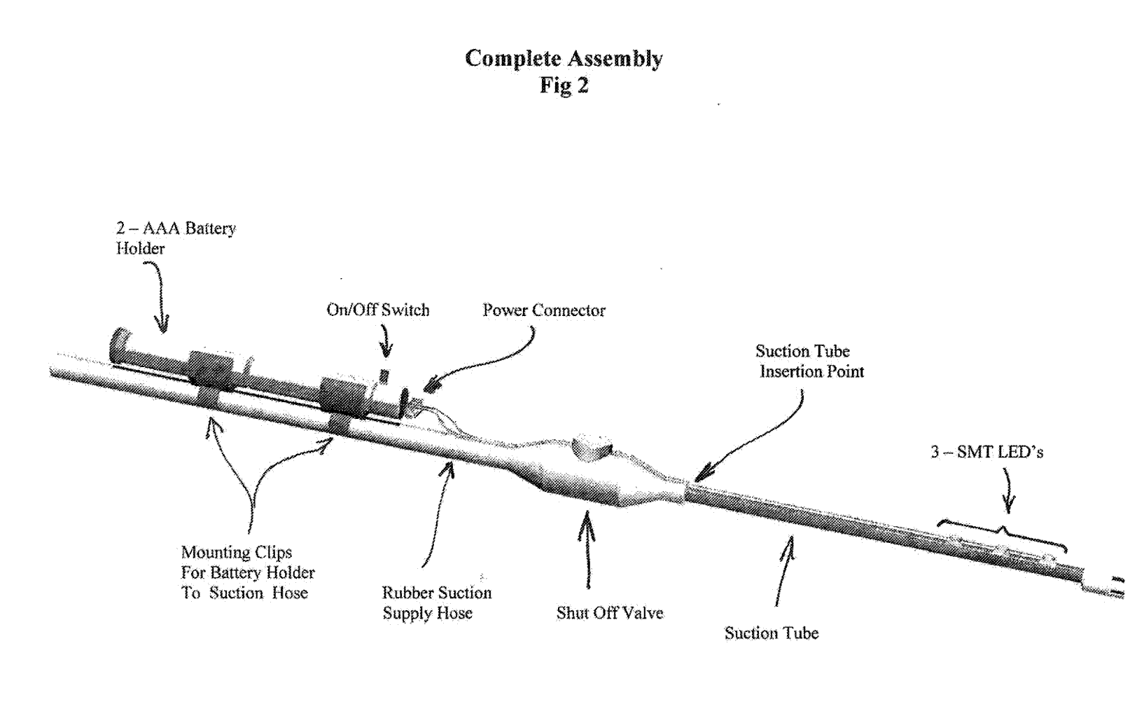

FIG. 2 shows the suction tube connected to a typical shut-off valve employed commonly by the dental professional. The ON/OFF valve is connected to a rubber extraction hose. Mounted with stainless steel clips, the battery holder is affixed to the extraction hose. The dual AAA battery holder incorporates an On/Off switch and a 2-pin electrical connector to accept the 2 pin connector coming from the LED strips on the suction tube.

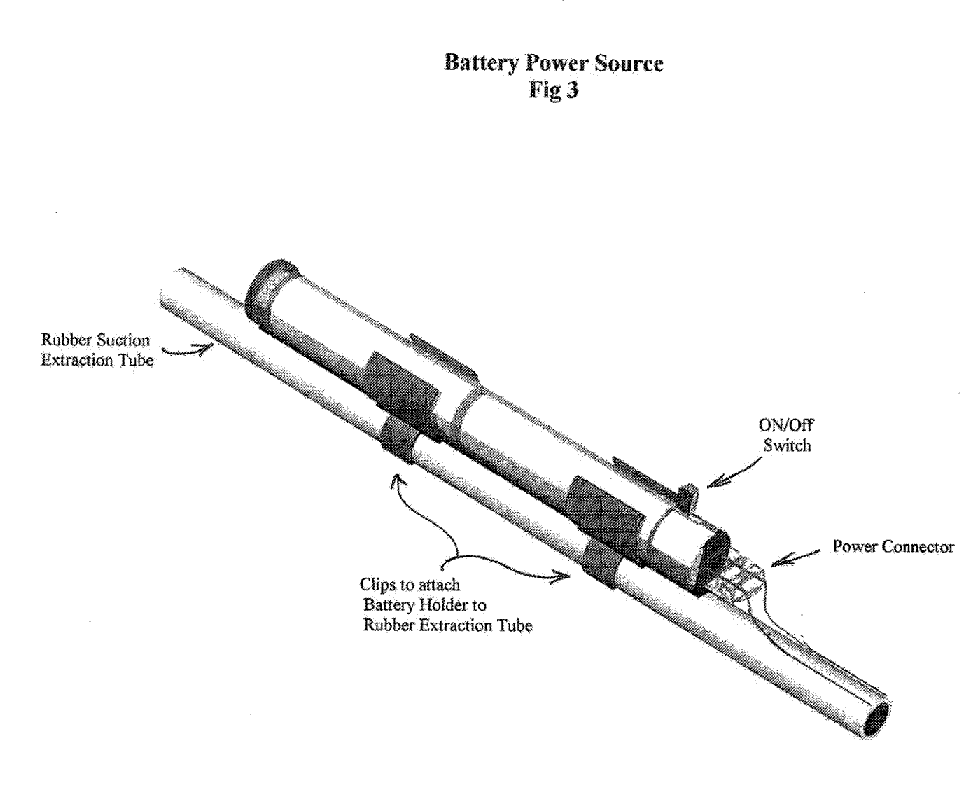

FIG. 3 shows how the battery holder power supply attached to the rubber extraction hose.

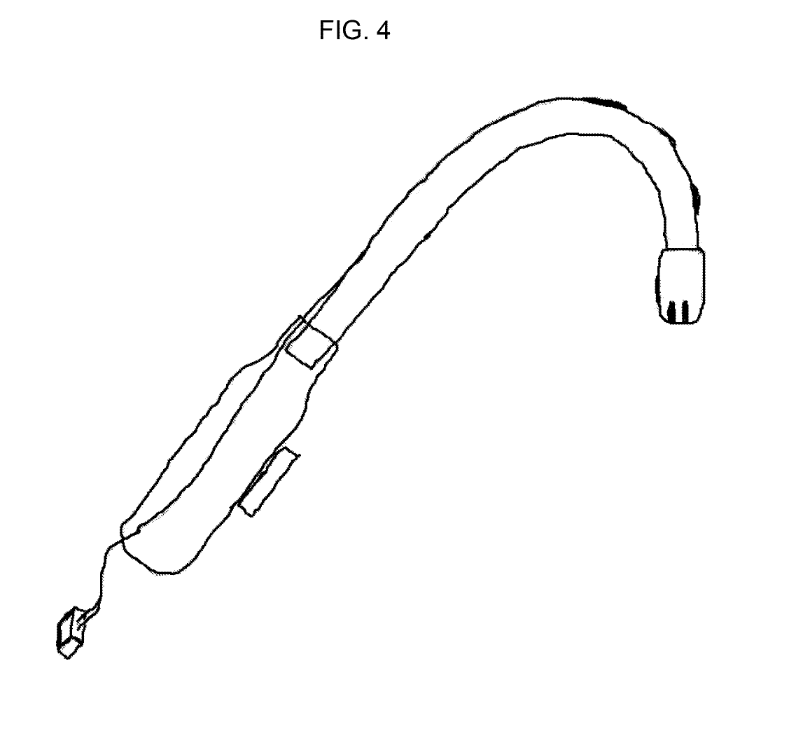

FIG. 4 shows a typical U-shaped LED suction device as it would normally be used by a dental professional in the dental industry.

I claim:

1. A teeth cleaning apparatus comprising:
a suction member; and
a light member;
the light member used to light the teeth being cleaned.

2. The apparatus of claim 1 wherein the light member further comprises LEDs.

3. The apparatus of claim 1 wherein the light member further comprises surface-mounted LEDs.

4. The apparatus of claim 1 wherein the suction member comprises a tube.

5. The apparatus of claim 1 further comprising a power supply.

6. The apparatus of claim 1 further comprising a shut off valve to control said suction member.

7. The apparatus of claim 1 wherein said suction member further comprises a flexible tube.

8. A teeth cleaning apparatus comprising:
a suction member;
a light member; and
a power supply.

9. The apparatus of claim 8 further comprising a shut off valve to control said suction member.

10. The apparatus of claim 8 wherein said suction member comprises a tube.

11. The apparatus of claim 8 wherein said suction member comprises a flexible tube.

12. The apparatus of claim 8 wherein said light member further comprises LEDs.

13. A teeth cleaning apparatus comprising:
a suction member;
a light member attached to said suction member;
a power supply; and
a shut off valve, said shut off valve operable to control said suction member.

14. The apparatus of claim 13 wherein said suction member comprises a tube.

15. The apparatus of claim 13 wherein said suction member comprises a flexible tube.

16. The apparatus of claim 13 wherein said light member comprises LEDs.

17. The apparatus of claim 13 wherein said power supply comprises a battery.
